(19) United States
(12) Patent Application Publication
(10) Pub. No.: US 2017/0017841 A1
(43) Pub. Date: Jan. 19, 2017

(54) METHOD AND APPARATUS FOR FACILITATING IMPROVED BIOMETRIC RECOGNITION USING IRIS SEGMENTATION

(71) Applicant: Nokia Technologies Oy, Espoo (FI)

(72) Inventors: Xin Chen, Evanston, IL (US); Xinyu Huang, Cary, NC (US)

(21) Appl. No.: 14/802,666

(22) Filed: Jul. 17, 2015

(51) Int. Cl. G06K 9/00; G06T 7/00; G06K 9/66

(52) U.S. Cl. CPC G06K 9/00617; G06K 9/66; G06T 7/0079

(57) ABSTRACT

Various methods are provided for facilitating biometric recognition. One example method may comprise receiving an image, the image comprising a plurality of pixels, generating a binary mask image from the image, the binary mask image identifying a plurality of target pixels from among the plurality of pixels, determining a first subset of misclassified target pixels by estimating a first boundary region and identifying a portion of target pixels that are outside of the first boundary region, and determining a second subset of misclassified target pixels by estimating a second boundary region and identifying a portion of target pixels that are within the second boundary region.

### TECHNOLOGICAL FIELD

Embodiments of the present invention relate generally to a method, apparatus, and computer program product for facilitating biometric recognition, and more specifically, for facilitating improved iris recognition using improved image processing techniques.

### BACKGROUND

Use of iris recognition in, for example, person identification is increasing because of the advantages irises provide in the identification of people. Specifically, irises are externally visible, unique to each individual, and hard to manipulate or hide. While traditional iris recognition techniques, such as circle, ellipse, or spline based methods, may perform adequately in lesser intrusive environments, such as when the subjects may be a short distance away from an image capturing device and/or moving at a certain speed. However, these traditional iris recognition techniques often fail in situations that produce noisy eye images, such as those eye images captured in unconstrained environments. For example, noisy eye images often contain noise caused by eyelids, eyelashes, environment reflections, shadows, or the like.

### BRIEF SUMMARY

A method, apparatus and computer program product are therefore provided according to an example embodiment of the present invention for facilitating biometric recognition, and more specifically, for facilitating improved iris recognition using improved image processing techniques. For example, iris recognition may be improved utilizing iris/non-iris segmentation by for example, applying deep learning techniques to segment an eye image into iris and non-iris regions.

In some embodiments, a method may be provided for facilitating biometric recognition, the method comprising receiving an image, the image comprising a plurality of pixels, generating a binary mask image from the image, the binary mask image identifying a plurality of target pixels from among the plurality of pixels, determining a first subset of misclassified target pixels by estimating a first boundary region and identifying a portion of target pixels that are outside of the first boundary region, and determining a second subset of misclassified target pixels by estimating a second boundary region and identifying a portion of target pixels that are within the second boundary region.

In some embodiments, the generation of the binary mask image comprises applying a label to each of the plurality of pixels of the image, the label identifying each of the plurality of pixels as one of a target pixel or a non-target pixel, wherein the application of the label to each of the plurality of pixels of the image is based on learned parameters, and causing output of each of the plurality of pixels identified as the plurality of target pixels, the output being the binary mask image.

In some embodiments, the determination of the first subset of misclassified pixels comprises receiving the binary mask image, performing edge detection to detect edges, estimating the first boundary region by performing a curve fitting process, identifying target pixels outside of the first boundary region, the target pixels outside of the first boundary region being the first subset of misclassified pixels, and re-classifying the target pixels identified as outside of the first boundary region to non-target pixels. In some embodiments, the curve fitting process is one of a circle fitting process, an ellipse fitting process, or a spline fitting process.

In some embodiments, the determination of the second subset of misclassified pixels comprises estimating the second boundary region by utilizing a second curve fitting, identifying target pixels within the second boundary region, the target pixels within the second boundary region being the second subset of misclassified pixels, and re-classifying the target pixels identified as within the second boundary region to non-target pixels.

In some embodiments, the first boundary region is an iris boundary region and the second boundary region is a pupil boundary region. In some embodiments, the edge detection process is a canny edge detection process. In some embodiments, the learning technique is a convolutional neural network. In some embodiments, the image is captured via a visible wavelength camera.

In some embodiments, an apparatus may be provided for facilitating biometric recognition, the apparatus comprising means for receiving an image, the image comprising a plurality of pixels, means for generating a binary mask image from the image, the binary mask image identifying a plurality of target pixels from among the plurality of pixels, means for determining a first subset of misclassified target pixels by estimating a first boundary region and identifying a portion of target pixels that are outside of the first boundary region, and means for determining a second subset of misclassified target pixels by estimating a second boundary region and identifying a portion of target pixels that are within the second boundary region.

In some embodiments, the means for generating of the binary mask image comprises means for applying a label to each of the plurality of pixels of the image, the label identifying each of the plurality of pixels as one of a target pixel or a non-target pixel, wherein the application of the label to each of the plurality of pixels of the image is based on learned parameters, and means for causing output of each of the plurality of pixels identified as the plurality of target pixels, the output being the binary mask image.

In some embodiments, the means for determining the first subset of misclassified pixels comprises means for receiving the binary mask image, means for performing edge detection to detect edges, means for estimating the first boundary region by performing a curve fitting process, means for identifying target pixels outside of the first boundary region, the target pixels outside of the first boundary region being the first subset of misclassified pixels, and means for re-classifying the target pixels identified as outside of the first boundary region to non-target pixels. In some embodiments, the curve fitting process is one of a circle fitting process, an ellipse fitting process, or a spline fitting process.

In some embodiments, the means for determining the second subset of misclassified pixels comprises means for estimating the second boundary region by utilizing a second curve fitting, means for identifying target pixels within the second boundary region, the target pixels within the second boundary region being the second subset of misclassified pixels, and means for re-classifying the target pixels identified as within the second boundary region to non-target pixels.

In some embodiments, the first boundary region is an iris boundary region and the second boundary region is a pupil boundary region. In some embodiments, the edge detection process is a canny edge detection process. In some embodiments, the learning technique is a convolutional neural network. In some embodiments, the image is captured via a visible wavelength camera.

In some embodiments, an apparatus may be provided for facilitating biometric recognition comprising at least one processor and at least one memory including computer program code, the at least one memory and the computer program code configured to, with the processor, cause the apparatus to at least receive an image, the image comprising a plurality of pixels, generate a binary mask image from the image, the binary mask image identifying a plurality of target pixels from among the plurality of pixels, determine a first subset of misclassified target pixels by estimating a first boundary region and identifying a portion of target pixels that are outside of the first boundary region, and determine a second subset of misclassified target pixels by estimating a second boundary region and identifying a portion of target pixels that are within the second boundary region.

In some embodiments, the at least one memory and the computer program code configured to generate the binary mask image is further configured to, with the processor, cause the apparatus to apply a label to each of the plurality of pixels of the image, the label identifying each of the plurality of pixels as one of a target pixel or a non-target pixel, wherein the application of the label to each of the plurality of pixels of the image is based on learned parameters, and cause output of each of the plurality of pixels identified as the plurality of target pixels, the output being the binary mask image.

In some embodiments, the at least one memory and the computer program code configured to determine the first subset of misclassified pixels is further configured to, with the processor, cause the apparatus to receive the binary mask image, perform edge detection to detect edges, estimate the first boundary region by performing a curve fitting process, identifying target pixels outside of the first boundary region, the target pixels outside of the first boundary region being the first subset of misclassified pixels, and re-classify the target pixels identified as outside of the first boundary region to non-target pixels. In some embodiments, the curve fitting process is one of a circle fitting process, an ellipse fitting process, or a spline fitting process.

In some embodiments, the at least one memory and the computer program code configured to determine the second subset of misclassified pixels is further configured to, with the processor, cause the apparatus to estimate the second boundary region by utilizing a second curve fitting, identify target pixels within the second boundary region, the target pixels within the second boundary region being the second subset of misclassified pixels, and re-classify the target pixels identified as within the second boundary region to non-target pixels.

In some embodiments, the first boundary region is an iris boundary region and the second boundary region is a pupil boundary region. In some embodiments, the edge detection process is a canny edge detection process. In some embodiments, the learning technique is a convolutional neural network. In some embodiments, the image is captured via a visible wavelength camera.

In some embodiments, a computer program product may be provided for facilitating biometric recognition, the computer program product comprising at least one non-transitory computer-readable storage medium having computer-executable program code instructions stored therein, the computer-executable program code instructions comprising program code instructions for receiving an image, the image comprising a plurality of pixels, generating a binary mask image from the image, the binary mask image identifying a plurality of target pixels from among the plurality of pixels, determining a first subset of misclassified target pixels by estimating a first boundary region and identifying a portion of target pixels that are outside of the first boundary region, and determining a second subset of misclassified target pixels by estimating a second boundary region and identifying a portion of target pixels that are within the second boundary region.

In some embodiments, the computer-executable program code instructions for generating the binary mask image further comprise program code instructions for applying a label to each of the plurality of pixels of the image, the label identifying each of the plurality of pixels as one of a target pixel or a non-target pixel, wherein the application of the label to each of the plurality of pixels of the image is based on learned parameters, and causing output of each of the plurality of pixels identified as the plurality of target pixels, the output being the binary mask image.

In some embodiments, the computer-executable program code instructions for determining the first subset of misclassified pixels further comprise program code instructions for receiving the binary mask image, performing edge detection to detect edges, estimating the first boundary region by performing a curve fitting process, identifying target pixels outside of the first boundary region, the target pixels outside of the first boundary region being the first subset of misclassified pixels, and re-classifying the target pixels identified as outside of the first boundary region to non-target pixels. In some embodiments, the curve fitting process is one of a circle fitting process, an ellipse fitting process, or a spline fitting process.

In some embodiments, the computer-executable program code instructions for determining the second subset of misclassified pixels further comprise program code instructions for estimating the second boundary region by utilizing a second curve fitting, identifying target pixels within the second boundary region, the target pixels within the second boundary region being the second subset of misclassified pixels, and re-classifying the target pixels identified as within the second boundary region to non-target pixels.

In some embodiments, the first boundary region is an iris boundary region and the second boundary region is a pupil boundary region. In some embodiments, the edge detection process is a canny edge detection process. In some embodiments, the learning technique is a convolutional neural network. In some embodiments, the image is captured via a visible wavelength camera.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is an example flowchart illustrating a method of operating an example apparatus in accordance with an embodiment of the present invention.

FIGS. 4A and 4B example flowcharts illustrating methods of operating an example apparatus in accordance with an embodiment of the present invention;

FIG. 5 is an example flowchart illustrating a method of operating an example apparatus in accordance with an embodiment of the present invention; and

FIG. 6 is an example flowchart illustrating a method of operating an example apparatus in accordance with an embodiment of the present invention.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or application specific integrated circuit for a mobile phone or a similar integrated circuit in a server, a cellular network device, or other network device.

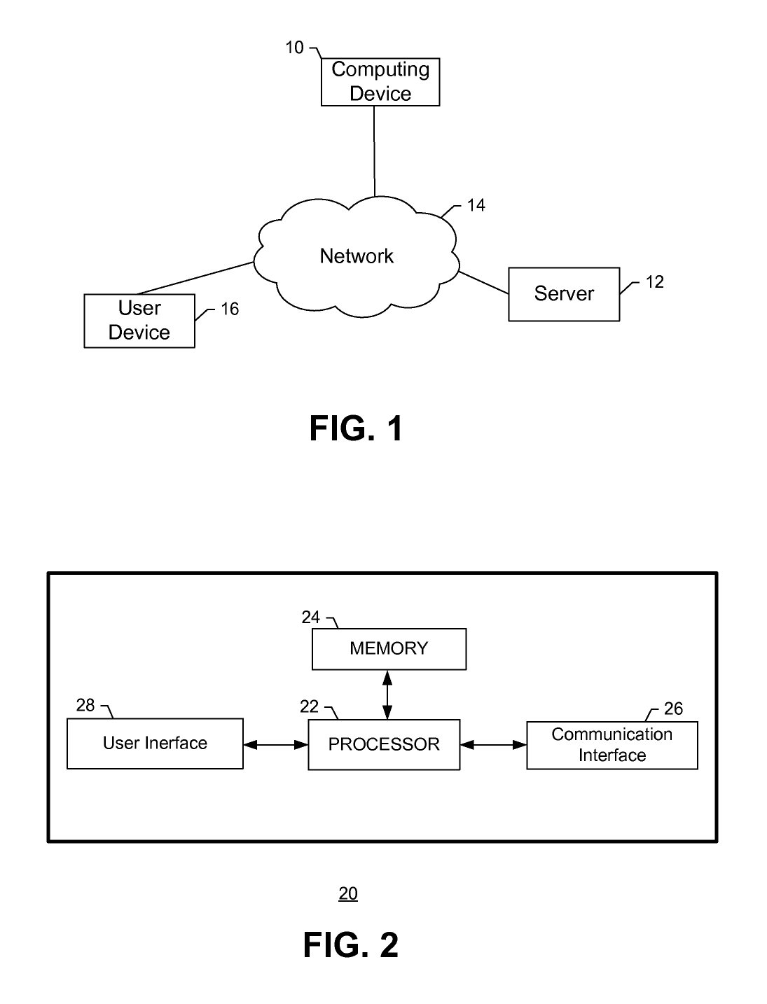

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet, or a local area network. However, the computing device and the server may be in communication in other manners, such as via direct communications between the computing device and the server. The user device 16 will be hereinafter described as a mobile terminal, but may be either mobile or fixed in the various embodiments

The computing device 10 and user device 16 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

In an example embodiment of the present invention, an apparatus or computer program product may be provided to implement or execute a method, process, or algorithm that applies deep learning techniques to segment an eye image into iris and non-iris regions.

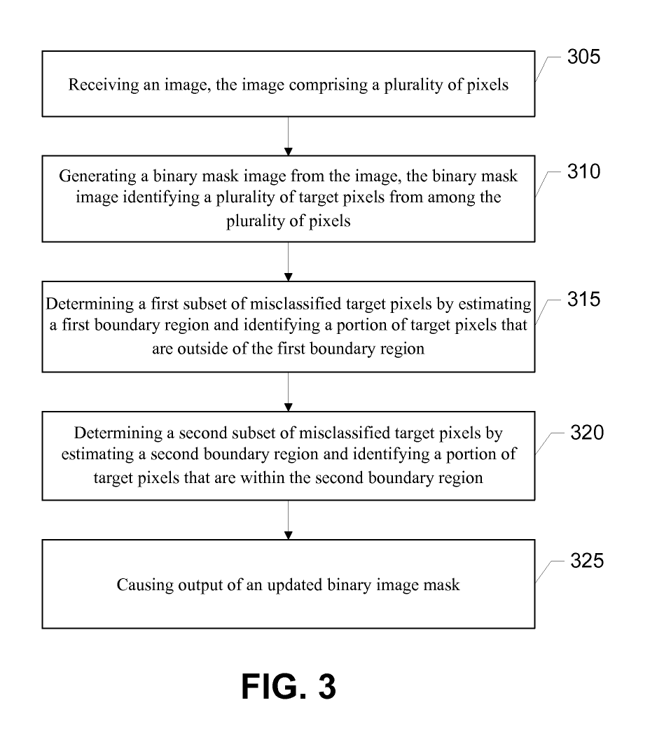

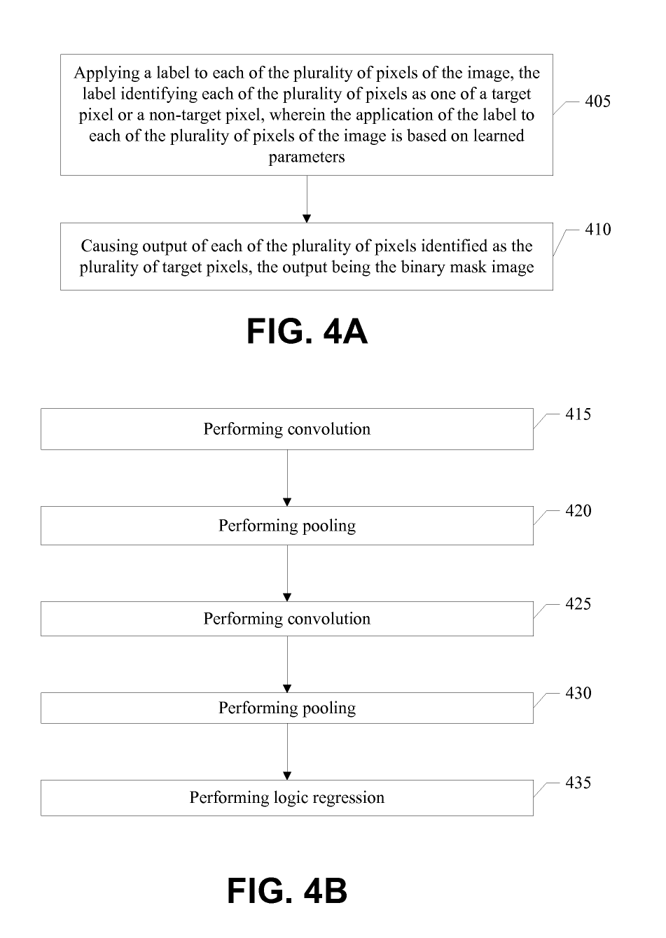

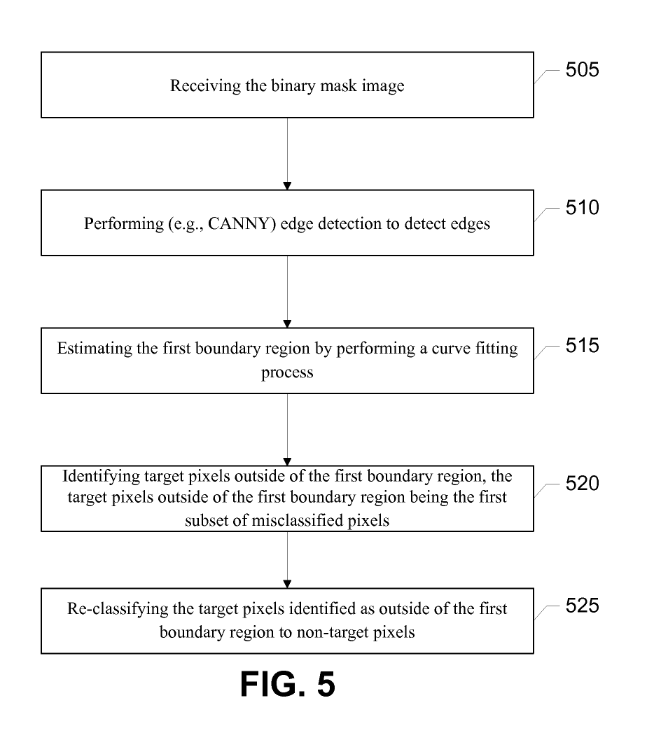

FIGS. 3, 4, and 5 illustrate example flowcharts of the example operations performed by a method, apparatus and computer program product in accordance with an embodiment of the present invention. FIG. 3 is shown from the perspective of the user device, FIG. 4 from the perspective of the server, and FIG. 5 from the perspective of the computing device. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3, 4, and 5, when executed, convert a computer or processing circuitry into a particular machine configured to perform an example embodiment of the present invention. Accordingly, the operations of FIGS. 3, 4, and 5 define an algorithm for configuring a computer or processing to perform an example embodiment. In some cases, a general purpose computer may be provided with an instance of the processor which performs the algorithms of FIGS. 3, 4, and 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included as shown by the blocks having a dashed outline in FIGS. 3, 4 and 5. It should be appreciated that each of the modifications, optional additions or amplifications below may be included with the operations above either alone or in combination with any others among the features described herein.

In some example embodiments, a method, apparatus and computer program product may be configured for facilitating biometric recognition, and more specifically, for facilitating improved iris recognition using improved image processing techniques. For example, iris recognition may be improved utilizing iris/non-iris segmentation by, for example, applying deep learning techniques to segment an eye image into iris and non-iris regions. Example embodiments of the present invention may be useful when, for example, the acquisition device is a visible wavelength camera or the like, and the image is captured in unconstrained environments, which often contain more noise (e.g., caused by eyelids, eyelashes, environment reflections, shadows, or the like).

FIG. 3 is an example flowchart illustrating a method for facilitating segmentation of an image by applying deep learning techniques, in accordance with an embodiment of the present invention. For example, an eye image (e.g., an image captured by an image capturing device comprising at least one eye of a subject). In some embodiments, segmentation may include (1) deep learning based segmentation; (2) segmentation refinement; and (3) pupil boundary estimation.

As such, as shown in block 305 of FIG. 3, an apparatus, such as apparatus 20 embodied by the user device 16, may be configured to receive an image, the image comprising a plurality of pixels. The apparatus embodied by user device 16 therefore includes means, such as the processor 22, the communication interface 26 or the like, for receiving an image, the image comprising a plurality of pixels. For example, the image may be that of an eye (e.g., an eye image, the eye including, for example, an iris, a pupil, and any of eyelids, eyelashes, environment reflections, shadows, skin regions, or the like).

As discussed above, in the first step of segmentation, deep learning networks may be applied to segment out the iris region or to segment the iris regions and the non-iris regions of the eye image. The deep learning networks may be convolutional neural networks (CNNs). That is, the apparatus may be configured to perform CNN based segmentation. The deep learning networks, or in some embodiments, the CNNs, may be trained by an annotated iris image data set. This step may then output a binary mask image that marks all possible iris pixels.

As such, as shown in block 310 of FIG. 3, an apparatus, such as apparatus 20 embodied by the user device 16, may be configured to generate a binary mask image from the image, the binary mask image identifying a plurality of target pixels from among the plurality of pixels. The apparatus embodied by user device 16 therefore includes means, such as the processor 22, the communication interface 26 or the like, for generating a binary mask image from the image, the binary mask image identifying a plurality of target pixels from among the plurality of pixels. Block 310 is further discussed with reference to FIGS. 4A and 4B.

As this binary mask image may still include or otherwise comprise misclassified pixels, in the second step, a curve fitting process (e.g., ellipse estimation) may be applied to further refine the segmentation results. Any iris pixels that are located outside the elliptical boundary may then be removed. That is the apparatus may be configured to perform segmentation refinement.

As such, as shown in block 315 of FIG. 3, an apparatus, such as apparatus 20 embodied by the user device 16, may be configured to determining a first subset of misclassified target pixels by, for example, estimating a first boundary region and identifying a portion of target pixels that are outside of the first boundary region. The apparatus embodied by user device 16 therefore includes means, such as the processor 22, the communication interface 26 or the like, for determining a first subset of misclassified target pixels by, for example, estimating a first boundary region and identifying a portion of target pixels that are outside of the first boundary region. In some embodiments, the first boundary region is an iris region of the eye image. Block 315 (e.g., segmentation refinement) is further discussed with reference to FIG. 5.

Subsequently, the binary mask image and a color image (e.g., the eye image) may be combined to estimate a pupil boundary inside the iris region. That is, the apparatus may be configured to perform pupil boundary estimation.

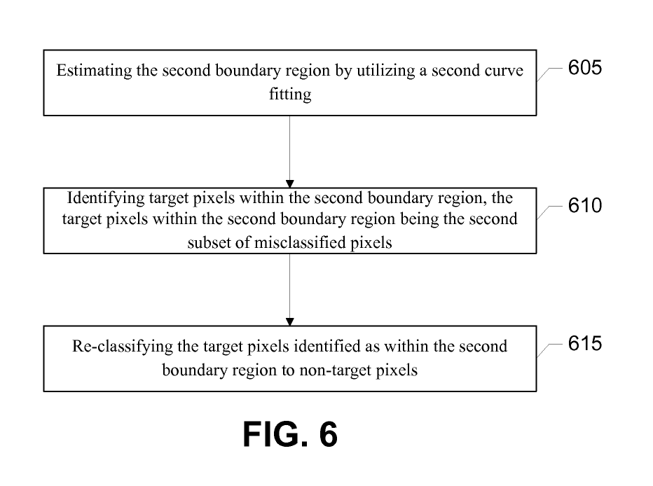

As such, as shown in block 320 of FIG. 3, an apparatus, such as apparatus 20 embodied by the user device 16, may be configured to determine a second subset of misclassified target pixels by, for example, estimating a second boundary region and identifying a portion of target pixels that are within the second boundary region. The apparatus embodied by user device 16 therefore includes means, such as the processor 22, the communication interface 26 or the like, for determining a second subset of misclassified target pixels by, for example, estimating a second boundary region and identifying a portion of target pixels that are within the second boundary region. Block 320 (e.g., pupil boundary estimation) is further discussed with reference to FIG. 6.

As shown in block 325 of FIG. 3, an apparatus, such as apparatus 20 embodied by the user device 16, may be configured to cause output of an updated binary image mask. The apparatus embodied by user device 16 therefore includes means, such as the processor 22, the communication interface 26 or the like, for causing output of an updated binary image mask. The updated binary image mask may comprise the plurality of target pixels. For example, updated binary image mask may comprise the plurality of target pixels from the binary image mask minus the first and second subset of misclassified target pixels, each of which having been removed and/or re-classified.

FIG. 4A is an example flowchart illustrating a method for deep learning based segmentation, in accordance with an embodiment of the present invention. As discussed above, in facilitating improved iris recognition using improved image processing techniques, embodiments of the present invention may be configured to provide improved iris/non-iris segmentation by, for example, applying deep learning techniques to segment an eye image into iris and non-iris regions.

As such, as shown in block 405 of FIG. 4, the apparatus 20 embodied by the server 12 may be configured to apply a label to each of the plurality of pixels of the image (e.g., the eye image), the label identifying each of the plurality of pixels as one of a target pixel or a non-target pixel. In some embodiments, the application of the label to each of the plurality of pixels of the image is based on learned parameters. The apparatus embodied by the computing device therefore includes means, such as the processor 22, the communication interface 26 or the like, for applying a label to each of the plurality of pixels of the image, the label identifying each of the plurality of pixels as one of a target pixel or a non-target pixel, the application of the label to each of the plurality of pixels of the image is based on learned parameters.

As shown in block 410 of FIG. 4, the apparatus 20 embodied by the server 12 may be configured to cause output of each of the plurality of pixels identified as the plurality of target pixels, the output being the binary mask image. The apparatus embodied by the computing device therefore includes means, such as the processor 22, the communication interface 26 or the like, for causing output of each of the plurality of pixels identified as the plurality of target pixels, the output being the binary mask image.

FIG. 4B is an example flowchart illustrating a method for deep learning based segmentation, and specifically, the utilization of CNNs, in accordance with an embodiment of the present invention. As one or ordinary skill in the art would understand, in machine learning, a CNN is a type of feed-forward artificial neural network where the individual neurons are tiled in such a way that they respond to overlapping regions in the visual field and are widely used models for image and video recognition.

In some embodiments of the present invention, image patches from training eye images may be randomly sampled. Many image patches in an eye image are, for example, smooth skin regions that are above or close to the iris region. These image patches often contain iris, pupil, eyelids, eyelashes, and eyebrows. The image patches may be normalized to, for example, N(0, 1).

When used for image recognition, CNNs may consist of multiple layers, each comprised of small portions of the input image. The results may then be tiled such that they overlap to obtain a better representation of the original image; this is repeated for every such layer. (W, u) are the parameters for each layer. The output h for each layer could be computed as hᵢ=tan h(pool(Wᵢhᵢ₋₁+uᵢ)), i=1, 2.

For example, h₁=tan h(pool(Wᵢ₁hᵢ₋₁+u₁)) may represent the output for a first layer. The function of the convolution operators is to extract different features of the input. The first convolution layers may obtain the low-level features, like edges, lines and corners. The more layers the network has, the higher-level features may be obtained. Accordingly, as shown in block 415 of FIG. 4, the apparatus 20 embodied by the server 12 may be configured to perform convolution. The apparatus embodied by the computing device therefore includes means, such as the processor 22, the communication interface 26 or the like, for performing convolution. Subsequently, in order to reduce variance, pooling layers may compute the maximum or average value of a particular feature over a region of the image, thus ensuring that the same result will be obtained, even when image features have small translations. Accordingly, as shown in block 420 of FIG. 4, the apparatus 20 embodied by the server 12 may be configured to perform pooling. The apparatus embodied by the computing device therefore includes means, such as the processor 22, the communication interface 26 or the like, for performing pooling.

Next, h₂=tan h(pool(W₂h₂₋₁+u₂)) may represent the output for a second layer. As described earlier, while the first convolution layer may obtain the low-level features, like edges, lines and corners. Additional convolution layers may obtain higher-level features. As shown in block 425 of FIG. 4, the apparatus 20 embodied by the server 12 may be configured to perform convolution. The apparatus embodied by the computing device therefore includes means, such as the processor 22, the communication interface 26 or the like, for performing convolution. As shown in block 430 of FIG. 4, the apparatus 20 embodied by the server 12 may be configured to cause pooling. The apparatus embodied by the computing device therefore includes means, such as the processor 22, the communication interface 26 or the like, for pooling.

Subsequently, logistic regression may then be used to transform the results into conditional probabilities using, for example, the softmax function.

$${\hat{c}}_{j} = \frac{{e}^{{w}_{j} h}}{{{e}^{{w}_{1}}}^{h} + {e}^{{w}_{2} h}}$$

where j=1, 2 represents two classes, iris and non-iris, and ĉⱼ denotes the predicted conditional probability. During the training stage, the sum of the negative log-likelihood functions for both CNNs may be minimized. For example, the minimization may be done by the stochastic gradient descent that is generally used in a standard CNN. Accordingly, as shown in block 435 of FIG. 4, the apparatus 20 embodied by the server 12 may be configured to perform logic regression. The apparatus embodied by the computing device therefore includes means, such as the processor 22, the communication interface 26 or the like, for performing logic regression.

Finally, during the predication stage, a label for each pixel is predicted based on learned parameters (W, u), which may be, for example:

\hat{l}=argmax(ĉ₁,ĉ₂)

FIG. 5 is an example flowchart illustrating segmentation refinement, in accordance with an embodiment of the present invention. For example, because a binary predication mask (e.g., the binary mask image) from the recurrent CNNs may still include misclassified pixels, estimation of the iris boundary may be performed. Specifically, segmentation refinement may be performed to remove the misclassified pixels or regions such that, for example, one large iris region remains after the segmentation refinement.

As such, as shown in block 505 of FIG. 5, an apparatus, such as apparatus 20 embodied by the user device 16, may be configured to receive the binary mask image. The apparatus embodied by user device 16 therefore includes means, such as the processor 22, the communication interface 26 or the like, for receiving the binary mask image.

In some embodiments, an edge detection process may first be applied. For example, the canny edge detector may first be applied to detect edges in the label predication. As such, as shown in block 510 of FIG. 5, an apparatus, such as apparatus 20 embodied by the user device 16, may be configured to performing edge detection to detect edges. The apparatus embodied by user device 16 therefore includes means, such as the processor 22, the communication interface 26 or the like, for performing edge detection to detect edges. For example, the apparatus may be configured for performing (e.g., canny) edge detection.

Subsequently, a curve (e.g., circle, ellipse, or spline) fitting may be used to estimate an iris boundary, and any predicated iris pixels outside the fitted curve may then be classified (or re-classified) to non-iris pixels. Accordingly, as shown in block 515 of FIG. 5, an apparatus, such as apparatus 20 embodied by the user device 16, may be configured to estimate the first boundary region by performing a curve fitting process. The apparatus embodied by user device 16 therefore includes means, such as the processor 22, the communication interface 26 or the like, for estimating the first boundary region by performing a curve fitting process. That is, in some embodiments, the apparatus may be configured for estimating an iris boundary using the curve fitting.

As such, as shown in block 520 of FIG. 5, an apparatus, such as apparatus 20 embodied by the user device 16, may be configured to identify target pixels (e.g., those pixels identified as iris pixels in CNN predication) outside of the first boundary region (e.g., the iris boundary region), the target pixels outside of the first boundary region being the first subset of misclassified pixels. The apparatus embodied by user device 16 therefore includes means, such as the processor 22, the communication interface 26 or the like, for identifying target pixels outside of the first boundary region, the target pixels outside of the first boundary region being the first subset of misclassified pixels. Subsequently, in some embodiments, the apparatus may be configured for classifying or re-classifying any predicated iris pixels outside the fitted curve as non-iris pixels. Accordingly, as shown in block 520 of FIG. 5, an apparatus, such as apparatus 20 embodied by the user device 16, may be configured to re-classify the target pixels identified as outside of the first boundary region to non-target pixels. The apparatus embodied by user device 16 therefore includes means, such as the processor 22, the communication interface 26 or the like, for re-classifying the target pixels identified as outside of the first boundary region to non-target pixels.

FIG. 6 is an example flowchart illustrating pupil boundary estimation, in accordance with an embodiment of the present invention. Note that, pupil boundary estimation is different from above iris boundary estimation in that, at least, it is hard to use only the predication mask (e.g., the binary mask image) to estimate pupil boundary. One reason may be that non-iris pixels inside iris region in the predication mask may be generated from eyelids, eyelashes, shadows, and environment reflections. Here, the fitted curve may be used to narrow down the search range of pupil boundary in the eye image. In some embodiments, another curve fitting may be used to estimate the pupil boundary.

As such, as shown in block 605 of FIG. 6, an apparatus, such as apparatus 20 embodied by the user device 16, may be configured to estimate a second boundary region by utilizing the first curve fitting or a second curve fitting. The apparatus embodied by user device 16 therefore includes means, such as the processor 22, the communication interface 26 or the like, for estimating the second boundary region by utilizing a second curve fitting.

As such, as shown in block 610 of FIG. 5, an apparatus, such as apparatus 20 embodied by the user device 16, may be configured to identify target pixels within the second boundary region, the target pixels within the second boundary region being the second subset of misclassified pixels. The apparatus embodied by user device 16 therefore includes means, such as the processor 22, the communication interface 26 or the like, for identifying target pixels within the second boundary region, the target pixels within the second boundary region being the second subset of misclassified pixels.

As such, as shown in block 615 of FIG. 5, an apparatus, such as apparatus 20 embodied by the user device 16, may be configured to re-classify the target pixels identified as within the second boundary region to non-target pixels. The apparatus embodied by user device 16 therefore includes means, such as the processor 22, the communication interface 26 or the like, for re-classifying the target pixels identified as within the second boundary region to non-target pixels.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for facilitating biometric recognition, the method comprising:
receiving an image, the image comprising a plurality of pixels;
generating a binary mask image from the image, the binary mask image identifying a plurality of target pixels from among the plurality of pixels;
determining a first subset of misclassified target pixels by estimating a first boundary region and identifying a portion of target pixels that are outside of the first boundary region; and
determining a second subset of misclassified target pixels by estimating a second boundary region and identifying a portion of target pixels that are within the second boundary region.

2. The method according to claim 1, where in the generation of the binary mask image comprises:
applying a label to each of the plurality of pixels of the image, the label identifying each of the plurality of pixels as one of a target pixel or a non-target pixel,
wherein the application of the label to each of the plurality of pixels of the image is based on learned parameters; and
causing output of each of the plurality of pixels identified as the plurality of target pixels, the output being the binary mask image.

3. The method according to claim 1, wherein the determination of the first subset of misclassified pixels comprises:
receiving the binary mask image;
performing edge detection to detect edges;
estimating the first boundary region by performing a curve fitting process;
identifying target pixels outside of the first boundary region, the target pixels outside of the first boundary region being the first subset of misclassified pixels; and
re-classifying the target pixels identified as outside of the first boundary region to non-target pixels.

4. The method according to claim 1, wherein the curve fitting process is one of a circle fitting process, an ellipse fitting process, or a spline fitting process.

5. The method according to claim 1, wherein determination of the second subset of misclassified pixels comprises:
estimating the second boundary region by utilizing a second curve fitting;
identifying target pixels within the second boundary region, the target pixels within the second boundary region being the second subset of misclassified pixels; and
re-classifying the target pixels identified as within the second boundary region to non-target pixels.

6. The method according to claim 1, wherein the first boundary region is an iris boundary region and the second boundary region is a pupil boundary region.

7. The method according to claim 1, wherein the edge detection process is a canny edge detection process.

8. The method according to claim 1, wherein the learning technique is a convolutional neural network.

9. The method according to claim 1, wherein the image is captured via a visible wavelength camera.

10. (canceled)

11. (canceled)

12. (canceled)

13. (canceled)

14. (canceled)

15. (canceled)

16. (canceled)

17. (canceled)

18. (canceled)

19. An apparatus for facilitating biometric recognition comprising at least one processor and at least one memory including computer program code, the at least one memory and the computer program code configured to, with the processor, cause the apparatus to at least:
receive an image, the image comprising a plurality of pixels;
generate a binary mask image from the image, the binary mask image identifying a plurality of target pixels from among the plurality of pixels;
determine a first subset of misclassified target pixels by estimating a first boundary region and identifying a portion of target pixels that are outside of the first boundary region; and
determine a second subset of misclassified target pixels by estimating a second boundary region and identifying a portion of target pixels that are within the second boundary region.

20. The apparatus according to claim 19, wherein the at least one memory and the computer program code configured to generate the binary mask image is further configured to, with the processor, cause the apparatus to:
apply a label to each of the plurality of pixels of the image, the label identifying each of the plurality of pixels as one of a target pixel or a non-target pixel,
wherein the application of the label to each of the plurality of pixels of the image is based on learned parameters; and
cause output of each of the plurality of pixels identified as the plurality of target pixels, the output being the binary mask image.

21. The apparatus according to claim 19, wherein the at least one memory and the computer program code configured to determine the first subset of misclassified pixels is further configured to, with the processor, cause the apparatus to:
receive the binary mask image;
perform edge detection to detect edges;
estimate the first boundary region by performing a curve fitting process;
identifying target pixels outside of the first boundary region, the target pixels outside of the first boundary region being the first subset of misclassified pixels; and
re-classify the target pixels identified as outside of the first boundary region to non-target pixels.

22. The apparatus according to claim 19, wherein the curve fitting process is one of a circle fitting process, an ellipse fitting process, or a spline fitting process.

23. The apparatus according to claim 19, wherein the at least one memory and the computer program code configured to determine the second subset of misclassified pixels is further configured to, with the processor, cause the apparatus to:
estimate the second boundary region by utilizing a second curve fitting;
identify target pixels within the second boundary region, the target pixels within the second boundary region being the second subset of misclassified pixels; and
re-classify the target pixels identified as within the second boundary region to non-target pixels.

24. The apparatus according to claim 19, wherein the first boundary region is an iris boundary region and the second boundary region is a pupil boundary region.

25. The apparatus according to claim 19, wherein the edge detection process is a canny edge detection process.

26. The apparatus according to claim 19, wherein the learning technique is a convolutional neural network.

27. The apparatus according to claim 19, wherein the image is captured via a visible wavelength camera.

28. A computer program product for facilitating biometric recognition, the computer program product comprising at least one non-transitory computer-readable storage medium having computer-executable program code instructions stored therein, the computer-executable program code instructions comprising program code instructions for:
receiving an image, the image comprising a plurality of pixels;
generating a binary mask image from the image, the binary mask image identifying a plurality of target pixels from among the plurality of pixels;
determining a first subset of misclassified target pixels by estimating a first boundary region and identifying a portion of target pixels that are outside of the first boundary region; and
determining a second subset of misclassified target pixels by estimating a second boundary region and identifying a portion of target pixels that are within the second boundary region.

29. The computer program product according to claim 28, wherein the computer-executable program code instructions for generating the binary mask image further comprise program code instructions for:
applying a label to each of the plurality of pixels of the image, the label identifying each of the plurality of pixels as one of a target pixel or a non-target pixel,
wherein the application of the label to each of the plurality of pixels of the image is based on learned parameters; and
causing output of each of the plurality of pixels identified as the plurality of target pixels, the output being the binary mask image.

30. The computer program product according to claim 28, wherein the computer-executable program code instructions for determining the first subset of misclassified pixels further comprise program code instructions for:
receiving the binary mask image;
performing edge detection to detect edges;
estimating the first boundary region by performing a curve fitting process;
identifying target pixels outside of the first boundary region, the target pixels outside of the first boundary region being the first subset of misclassified pixels; and
re-classifying the target pixels identified as outside of the first boundary region to non-target pixels.

31. The computer program product according to claim 28, wherein the curve fitting process is one of a circle fitting process, an ellipse fitting process, or a spline fitting process.

32. The computer program product according to claim 28, wherein the computer-executable program code instructions for determining the second subset of misclassified pixels further comprise program code instructions for:
estimating the second boundary region by utilizing a second curve fitting;
identifying target pixels within the second boundary region, the target pixels within the second boundary region being the second subset of misclassified pixels; and
re-classifying the target pixels identified as within the second boundary region to non-target pixels.

33. The computer program product according to claim 28, wherein the first boundary region is an iris boundary region and the second boundary region is a pupil boundary region.

34. The computer program product according to claim 28, wherein the edge detection process is a canny edge detection process.

35. The computer program product according to claim 28, wherein the learning technique is a convolutional neural network.

36. The computer program product according to claim 28, wherein the image is captured via a visible wavelength camera.
